(19) United States
(12) Patent Application Publication
(10) Pub. No.: US 2019/0384113 A1
(43) Pub. Date: Dec. 19, 2019

(54) LIQUID CRYSTAL DISPLAY AND BACKLIGHT MODULE THEREOF

(71) Applicant: HUIZHOU CHINA STAR OPTOELECTRONICS TECHNOLOGY CO., LTD., Huizhou Guangdong (CN)

(72) Inventor: Ching-yuan CHENG, Huizhou Guangdong (CN)

(21) Appl. No.: 15/754,575

(22) PCT Filed: Nov. 14, 2017
(86) PCT No.: PCT/CN2017/110818

§ 371 Date: Feb. 22, 2018

(30) Foreign Application Priority Data
Oct. 13, 2017 (CN) 201710953927.0

(51) Int. Cl. G02F 1/1335; G02F 1/1339; G02F 1/1337

(52) U.S. Cl. CPC G02F 1/133603; G02F 1/133707; G02F 1/1339; G02F 1/133605

(57) ABSTRACT

A liquid crystal display and a backlight module thereof are provided. The backlight module includes a fixing component, a light source, and a light guide. The light source and the light guide are arranged on the fixing component. The light source further includes a printed circuit board (PCB) and a plurality of light emitting diode (LED) lamps. The surface of the PCB that faces toward the light guide is provided with a plurality of recesses. The plurality of recesses respectively correspond to the plurality of LED lamps. The plurality of LED lamps are respectively installed in the plurality of recesses and arranged opposite to the light incident surface of the light guide. The backlight module further includes an adhesive layer between the light source and the light guide. The adhesive layer covers the PCB, the surface of the LED lamp, and the light incident surface of the light guide.

### RELATED APPLICATIONS

The present application is a National Phase of International Application Number PCT/CN2017/110818, filed Nov. 14, 2017, and claims the priority of China Application No. 201710953927.0, filed Oct. 13, 2017.

### FIELD OF THE DISCLOSURE

The disclosure relates to a liquid crystal display technical field, and more particularly to a liquid crystal display and a backlight module thereof.

### BACKGROUND

In a thinning backlight module, the size of a light guide is similar to that of LED lamps. Thus, the LED lamp is precisely aligned to the light guide when assembling them. Or otherwise, the light emitted from the LED lamps is not incident on the light guide to reduce the usage of light energy. It is more difficult to align and assemble a full lamination backlight module without a backplane since a light guide is lacked to position the backlight module. When the backlight module without a back plane is assembled, LED lamps are fixed to an aluminum extrusion and then the aluminum extrusion is fixed to a light guide. In the process, due to the size tolerance of the aluminum extrusion and the man-made assembling tolerance caused by two lamination processes, the LED lamps are more difficultly aligned to the light guide in this architecture.

### SUMMARY

A technical problem to be solved by the disclosure is to provide a liquid crystal display and a backlight module thereof, wherein the backlight module has a simple structure and improves the lighting efficiency of a light source.

An objective of the disclosure is achieved by following embodiments. In particular, a backlight module comprising a fixing component, a light source, and a light guide plate, the light source and the light guide are arranged on the fixing component, the light source further comprises a printed circuit board (PCB) and a plurality of light emitting diode (LED) lamps, a surface of the PCB that faces toward the light guide plate is provided with a plurality of recesses, the plurality of recesses respectively correspond to the plurality of LED lamps, the plurality of LED lamps are respectively installed in the plurality of recesses and arranged opposite to an light incident surface of the light guide plate, the backlight module further comprises an adhesive layer between the light source and the light guide plate, and the adhesive layer covers the PCB, a surface of the LED lamp, and the light incident surface of the light guide plate.

In an embodiment, a surface of the LED lamp that faces toward the light guide plate is level with the surface of the PCB that faces toward the light guide plate.

In an embodiment, the fixing component comprises a horizontal portion and a vertical portion, the horizontal portion is bended and extended to form the vertical portion, the light guide plate is fixed to the horizontal portion, and the PCB is fixed to the vertical portion.

In an embodiment, a refractive index of the adhesive layer is equal to that of the light guide plate.

In an embodiment, the plurality of LED lamps are arranged into a straight line, and an interval between the two neighboring LED lamps is equal.

In an embodiment, the fixing component comprises aluminum.

In an embodiment, the backlight module further comprises a reflection layer arranged on a bottom of the light guide plate.

In an embodiment, the reflection layer is a reflective plate.

In an embodiment, the reflection layer is a reflective coating layer coated on the bottom of the light guide plate.

According to another aspect of the disclosure, the disclosure further provides a liquid crystal display. The liquid crystal display includes a display module and a backlight module as described above. The display module is arranged on the light guide plate.

The backlight module comprises a light source and a light guide plate. The light source further comprises a printed circuit board (PCB) and a plurality of light emitting diode (LED) lamps, a surface of the PCB that faces toward the light guide plate is provided with a plurality of recesses. The plurality of LED lamps are respectively installed in the plurality of recesses to simplify the structure of the light source. The light source is fixed to a light incident surface of the light guide plate through an adhesive layer to prevent from dislocations between the LED lamps and the light guide plate when assembling the LED lamps and the light guide plate, thereby improving the light efficiency of the light source.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structural schematic view of a liquid crystal display according to an embodiment of the disclosure; and

FIG. 2 is a structural schematic view of a backlight module according to an embodiment of the disclosure.

### DETAILED DESCRIPTION OF PREFERRED EMBODIMENTS

Reference will now be made in detail to embodiments illustrated in the accompanying drawings. Wherever possible, the same reference numbers are used in the drawings and the description to refer to the same or like parts. It is to be understood that elements not specifically shown or described may take various forms well known to those skilled in the art. Many alternatives and modifications will be apparent to those skilled in the art, once informed by the present disclosure.

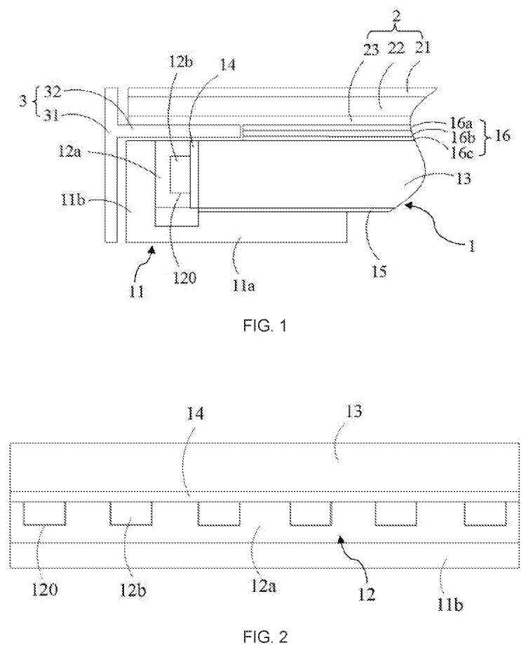

Refer to FIG. 1 and FIG. 2. The liquid crystal display comprises a backlight module 1 and a display module 2. The backlight module 1 comprises a fixing component 11, a light source 12, and a light guide plate 13, the light source 12 and the light guide plate 13 are arranged on the fixing component 11. The light source 12 further comprises a printed circuit board (PCB) 12a and a plurality of light emitting diode (LED) lamps 12b. The surface of the PCB 12a that faces toward the light guide plate 13 is provided with a plurality of recesses 120. The plurality of recesses 120 respectively correspond to the plurality of LED lamps 12b. The plurality of LED lamps 12b are respectively installed in the plurality of recesses 120 and arranged opposite to a light incident surface of the light guide plate 13. The backlight module 1 further comprises an adhesive layer 14 between the light source 12 and the light guide plate 13, and the adhesive layer 14 covers the PCB 12a, a surface of the LED lamp 12b, and the light incident surface of the light guide plate 13.

In the embodiment, the light incident surface of the light guide plate 13 refers to the surface of the light guide plate 13 that faces toward the light source 12. The surface of the LED lamp 12 that faces toward the light guide plate 13 is level with the surface of the PCB 12a that faces toward the light guide plate 13, such that the adhesive layer 14 is uniformly coated between the light source 12 and the light guide plate 13. The light source 12 is fixed to the light guide plate 13 through the adhesive layer 14. In this way, when the backlight module 1 is assembled, dislocations between the LED lamps 12b and the light guide plate 13 do not occur, and all light beams emitted by the LED lamps 12b are not incident on the light guide plate 13 to reduce the lighting efficiency of the light source 12. The adhesive layer 14 may be a double sided tape or a glue. The refractive index of the adhesive layer 14 is equal to that of the light guide plate 13. As a result, the Fresnel loss produced by different mediums can be reduced to improve the lighting efficiency of the light source 12.

Specifically, the fixing component 11 fixes the light source 12 and the light guide plate 13. The fixing component 11 comprises a horizontal portion 11a and a vertical portion 11b vertical to the horizontal portion 11a. The horizontal portion 11a is bended and extended to form the vertical portion 11b. The light guide plate 13 is fixed to the horizontal portion 11a and arranged in parallel to the horizontal portion 11a. The PCB 12a is fixed to the vertical portion 11b and arranged in parallel to the vertical portion 11b. The PCB 12a is located between the vertical portion 11b and the light guide plate 13.

In the embodiment, the fixing component 11 comprises aluminum. The fixing component 11 fixes the light source 12 and the light guide plate 13. Besides, the fixing component 11 is used as a heat dissipating structure of the backlight module 1 and more effectively transmit the heat of the PCB 12a to outside.

The plurality of LED lamps 12b are arranged into a straight line, and an interval between two neighboring LED lamps 12b is equal. In the embodiment, the LED lamp 12b consists of a lighting chip and a transparent lampshade. The lighting chip is packaged in the transparent lampshade. The lighting chip may be a white-light lighting chip that emits white light. The lighting chip may be a blue-light lighting chip that emits blue light. When the lighting chip is a blue-light lighting chip, the LED lamp 12b further comprises a fluorescent material coated on the inner surface of the transparent lampshade. The fluorescent material may be fluorescent powder with yellow, fluorescent powder with red and green, and fluorescent powder with yellow and red. The blue-light lighting chip emits blue light to stimulate the fluorescent material, such that the light emitted from the transparent lampshade is white light.

The backlight module further comprises a reflection layer 15 arranged on a bottom of the light guide plate 13. The reflection layer 15 may be a single reflective plate arranged between the horizontal portion 11a and the light guide plate 13. The reflection layer 15 may be a reflective coating layer coated on the bottom of the light guide plate 13.

The backlight module 1 further comprises an optical film set 16 on the top of the light guide plate 13. The optical film set 16 includes an upper diffuser film 16a, a brightness enhancement film 16b, and a lower diffuser film 16c. The upper diffuser film 16a is arranged between the brightness enhancement film 16b and the display module 2. The lower diffuser film 16c is arranged between the brightness enhancement film 16b and the light guide plate 13. The lower diffuser film 16c focuses the light emitted from the light-emitting surface of the light guide plate 13 to uniformly cast on the brightness enhancement film 16b. The brightness enhancement film 16b focuses the distributed light emitted from the lower diffuser film 16c to improve the brightness. The upper diffuser film 16a nebulizes the light emitted from the brightness enhancement film 16b to uniformly emit the light.

The display module 2 includes an upper polarizer 21, a display assembly 22, and a lower polarizer 23. The display assembly 22 is arranged between the upper polarizer 21 and the lower polarizer 23. The lower polarizer 23. Is arranged between the display assembly 22 and the upper diffuser film 16a.

The plurality of LED lamps 12b are respectively installed in the plurality of recesses 120 and the surface of the LED lamp 12b is level with the surface of the PCB 12a to simplify the structure of the light source 12. The light source 12 is fixed to a light incident surface of the light guide plate 13 through the adhesive layer 14 to prevent from dislocations between the LED lamps 12b and the light guide plate 13 when assembling the LED lamps 12b and the light guide plate 13, thereby improving the light efficiency of the light source 12. In addition, the refractive index of the adhesive layer 14 is equal to that of the light guide plate 13. As a result, the Fresnel loss produced by different mediums can be reduced to improve the lighting efficiency of the light source 12.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A backlight module comprising a fixing component, a light source and a light guide plate arranged on the fixing component, wherein the light source further comprises a PCB and a plurality of LED lamps, a surface of the PCB that faces toward the light guide plate is provided with a plurality of recesses, the plurality of recesses respectively correspond to the plurality of LED lamps, the plurality of LED lamps are respectively installed in the plurality of recesses and arranged opposite to a light-incident surface of the light guide plate, the backlight module further comprises an adhesive layer between the light source and the light guide plate, and the adhesive layer covers the PCB, a surface of the LED lamp, and the light-incident surface of the light guide plate.

2. The backlight module according to claim 1, wherein a surface of the LED lamp that faces toward the light guide plate is level with the surface of the PCB that faces toward the light guide plate.

3. The backlight module according to claim 2, wherein the fixing component comprises a horizontal portion and a vertical portion, the horizontal portion is bended and extended to form the vertical portion, the light guide plate is fixed to the horizontal portion, and the PCB is fixed to the vertical portion.

4. The backlight module according to claim 3, wherein a refractive index of the adhesive layer is equal to that of the light guide plate.

5. The backlight module according to claim 1, wherein the plurality of LED lamps are arranged into a straight line, and an interval between two neighboring LED lamps is equal.

6. The backlight module according to claim 1, wherein the fixing component comprises aluminum.

7. The backlight module according to claim 1, further comprising a reflection layer arranged on a bottom of the light guide plate.

8. The backlight module according to claim 7, wherein the reflection layer is a reflective plate.

9. The backlight module according to claim 7, wherein the reflection layer is a reflective coating layer coated on the bottom of the light guide plate.

10. A liquid crystal display comprising a display module and a backlight module, wherein the display module is arranged on a light guide plate, the backlight module comprises a fixing component, a light source and the light guide plate are arranged on the fixing component, the light source further comprises a PCB and a plurality of LED lamps, a surface of the PCB that faces toward the light guide plate is provided with a plurality of recesses, the plurality of recesses respectively correspond to the plurality of LED lamps, the plurality of LED lamps are respectively installed in the plurality of recesses and arranged opposite to a light-incident surface of the light guide plate, the backlight module further comprises an adhesive layer between the light source and the light guide plate, and the adhesive layer covers the PCB, a surface of the LED lamp, and the light-incident surface of the light guide plate.

11. The liquid crystal display according to claim 10, wherein a surface of the LED lamp that faces toward the light guide plate is level with the surface of the PCB that faces toward the light guide plate.

12. The liquid crystal display according to claim 11, wherein the fixing component comprises a horizontal portion and a vertical portion, the horizontal portion is bended and extended to form the vertical portion, the light guide plate is fixed to the horizontal portion, and the PCB is fixed to the vertical portion.

13. The liquid crystal display according to claim 12, wherein a refractive index of the adhesive layer is equal to that of the light guide plate.

14. The liquid crystal display according to claim 10, wherein the plurality of LED lamps are arranged into a straight line, and an interval between two neighboring LED lamps is equal.

15. The liquid crystal display according to claim 10, wherein the fixing component comprises aluminum.

16. The liquid crystal display according to claim 10, further comprising a reflection layer arranged on a bottom of the light guide plate.

17. The liquid crystal display according to claim 16, wherein the reflection layer is a reflective plate.

18. The liquid crystal display according to claim 16, wherein the reflection layer is a reflective coating layer coated on the bottom of the light guide plate.
